(19) United States
(12) Patent Application Publication
(10) Pub. No.: US 2011/0095516 A1
(43) Pub. Date: Apr. 28, 2011

(54) Organization System

(76) Inventors: LIZ REGENOLD, WEST DES MOINES, IA (US); JEFF REGENOLD, WEST DES MOINES, IA (US)

(21) Appl. No.: 12/437,278

(22) Filed: May 7, 2009

(51) Int. Cl. B42D 5/04; B42C 19/00

(52) U.S. Cl. 283/3; 412/1

(57) ABSTRACT

A method and system is provided for assisting students in organization. A complete system is provided that includes a planner with schedule sheets, folders, and a carrying case. The system is customized for a particular group, including a school district, a school, a classroom, or an individual student. The customization includes assigning a color to each academic subject matter and organizing each schedule sheet in order of academic schedule and by school day.

### BACKGROUND OF THE INVENTION

This invention relates generally to an organizational system and more particularly to an organizational system including a customizable planner.

Organization is a life skill that requires discipline and repetition to achieve. Developing these skills at a young age not only helps with schoolwork, but will also continue to help students organize their thoughts and activities throughout their lives.

Students struggling in school or to stay organized may frequently lose assignments, misplace notes, or miss deadlines. Parents may not he kept informed of their child's assignments and teachers may have too many students to be able to provide one-on-one help with remembering deadlines or staying organized.

There are many products or planners to help with organization, but these systems are difficult and time consuming to customize to a certain school's or an individual student's particular schedule or needs. Further, historically there has not been a complete system that incorporates a customized planner with an integrated system for keeping assignments and other papers organized.

Organizational systems in the prior art include the system described in U.S. Pat. No. 6,364,362 to Severin. Severin describes a complicated color-coordinated organizational system that includes a master planner and a plurality of mini-systems. The Severin system is not customized based on an individual student's schedule, or a school's schedule.

Another organizational system shown in the prior art is U.S. patent application Ser. No. 09/920,087 to Jones. Jones shows a color-coded planner system, but again does not described using the color-coded system to personalize the system for a student, a class, or a school.

Thus, the need exists for a comprehensive organizational system that is customized at different levels, including for an individual student, for a class, for a school, or for a district.

### SUMMARY OF THE INVENTION

It is an object of the present invention to provide a customized planner.

It is a further object of the present invention to provide a customized organizational system.

These and other objects of the present invention will become apparent to those skilled in the art upon reference to the following specification, drawings, and claims.

### BRIEF DESCRIPTION OF THE DRAWINGS

FIG. 1 is a view of the organization system of the present invention.

FIG. 2a is an open view of the planner of the present invention.

FIG. 2b is an open view of the planner of the present invention.

FIG. 2c is a view of one day of the planner of the present invention.

FIG. 3 is a view of the organizational folders of the present invention.

FIG. 4a is a front view of one of the carrying cases of the present invention.

FIG. 4b is a back view of one of the carrying cases of the present invention.

FIG. 4c is an inside view of one of the carrying cases of the present invention.

FIG. 5 is a view of the assembled system of the present invention.

FIG. 6a is a view of a manually customizable embodiment of a tab sheet of the present invention.

FIG. 6b is a view of a manually customizable embodiment of a tab sheet with schedule sheets of the present invention.

FIG. 6c is a view of a manually customizable embodiment of the folders of the present invention.

FIG. 6d is a view of a manually customizable embodiment of the folders of the present invention.

FIG. 7 is a schematic showing the options for customizing the organization system of the present invention.

### DETAILED DESCRIPTION OF THE INVENTION

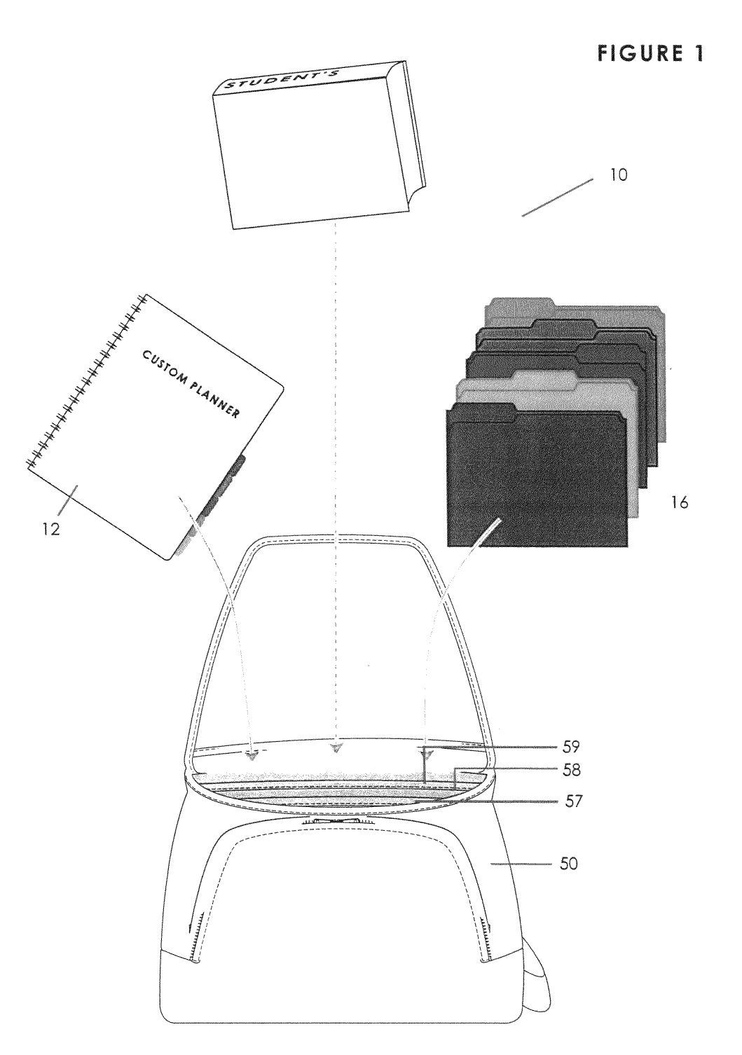

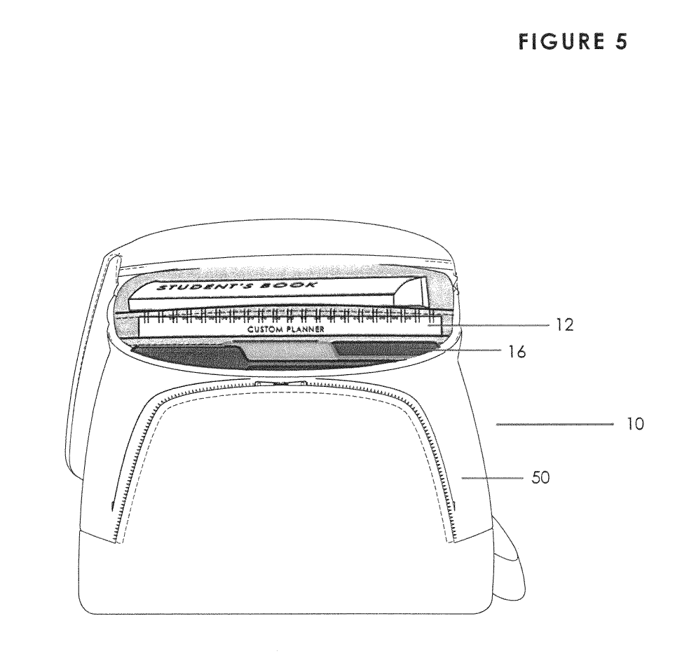

The organizational system 10 is shown generally in the Figures. FIGS. 1 and 5 generally illustrate the system of the present invention 10. The system generally includes a customized planner 12, customized folders 16, and a carrying case 50.

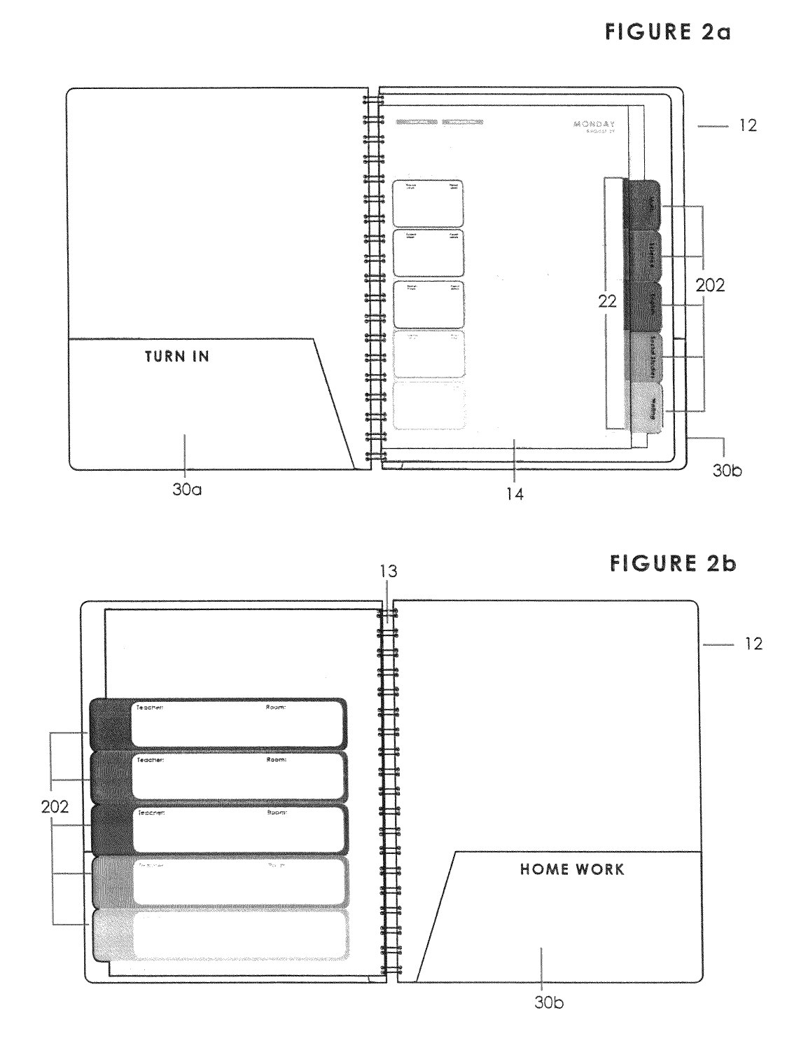

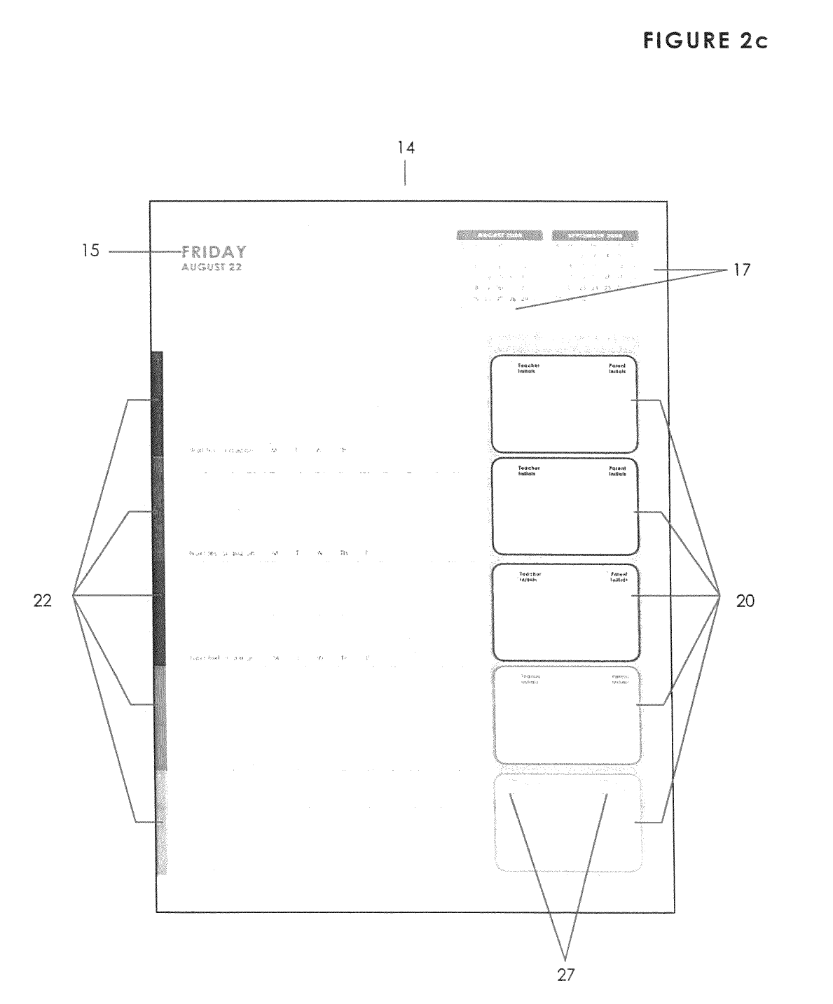

The planner 12 of the organizational system 10 of the present invention is seen generally in FIGS. 2a-2c . The planner may be spiral bound or otherwise fastened with customized pages. The customized pages may be periodically replenished, such as yearly, quarterly, etc. The planner 12 includes schedule sheets 14 that are customized. The schedule sheets may be customized for the student's personal schedule, and for the school's monthly schedule. The customization may occur at different levels than for an individual student, for a class, for a school, or for a school district. In one embodiment, the customization involves color-coding, so that each subject matter studied is assigned a different color. For example, math may be assigned the color blue. Every component of the system that is assigned to math is printed in blue.

As shown in detail in FIG. 2c, the planning sheets include the date 15, and a monthly calendar 17 may be included on each schedule sheet that matches the school's schedule, tracking holidays and early dismissals. Each schedule sheet 14 includes space for parent/teacher communication 20, with boxes for initialing for daily tracking. For example, the parent and teacher can write notes on each schedule sheet 14, or initial that they have reviewed the student's notes regarding assignments for the day. The parent and teacher can initial or note that they have reviewed the student's work product. Each schedule sheet 14 includes color-coded space 22 for each of the student's classes for the day, organized in the same order as the student's classes. For example, in FIG. 2c, the student attends math first, and math has been assigned the color blue. Not only is the area in the schedule sheet 14 reserved for math colored blue, all folders or other organizational components of the system 10 devoted to math are also blue. It will be understood by one of skill in the art that the schedule sheets 14 may include one day, or multiple days, to best suit a student's needs. For example, younger students with larger handwriting will typically use a schedule sheet showing the schedule for one day, while older students may use schedule sheets with more days per page, such as all five days over a two-page spread.

The planner 12 further includes at least one pocket 30a, as seen in FIG. 2b. The pocket 30a holds assignments. If multiple pockets are employed, one pocket holds assignments yet to be completed 30a (a Homework pocket) and the other 30b (a Turn In pocket) holds finished assignments for transport back to school. Simply opening the planner 12 immediately reminds the student of actions to take.

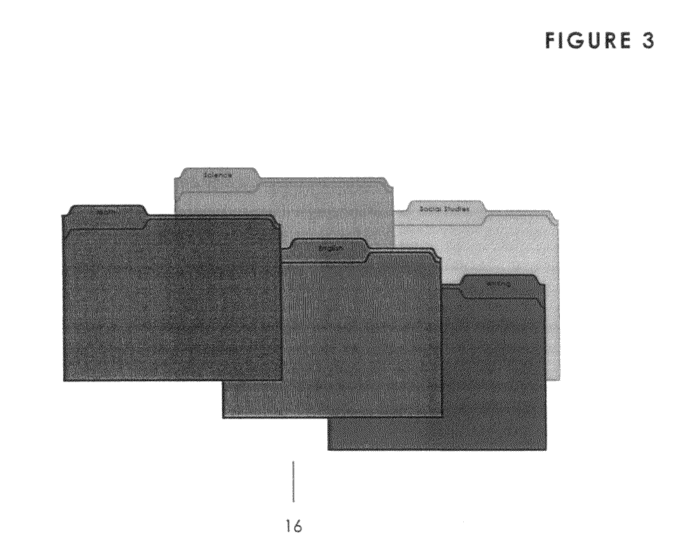

As shown in FIG. 3, color-coded folders 16 are used to separate materials for each subject matter. Each folder 16 represents an individual class and helps keep ideas and materials coordinated by matching the folder colors to the planner 12, and specifically to the color coded spaces 22 and parent/teacher communication boxes 20 of the day sheet 14. Individual folders 16 are easily removed for teachers or parents to help the student review materials.

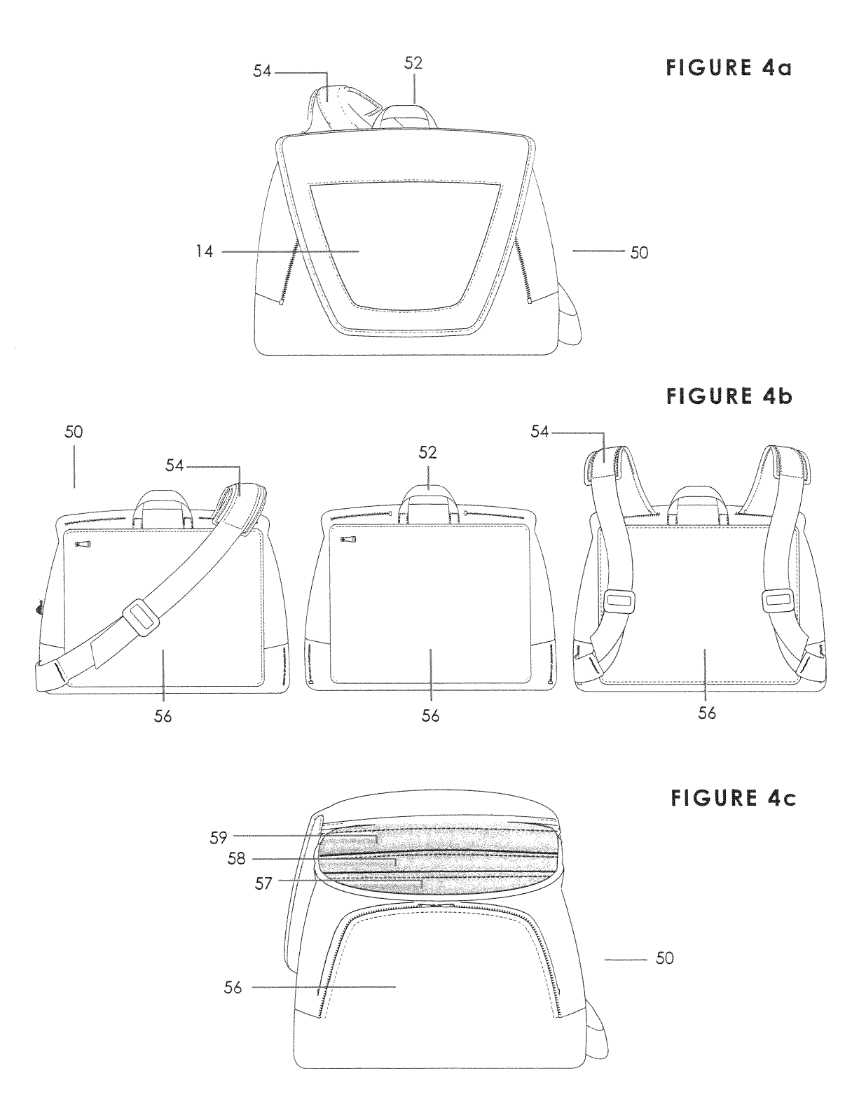

The folders 16 and the planner 12 fit into a case 50, as shown in FIGS. 4a-4c. The case 50 may include handles 52 and/or a shoulder strap 54, and may be modified as a backpack, messenger bag, or briefcase. The case 50 may also include a pouch 56 for school supplies. The case 50 is divided into three compartments 57, 58, 59. The compartments are all adjustable and removable for further customization. In a typical example, the first compartment 57 holds the folders 16 for classes that occur before lunch (and in the order that the student attends those classes). The middle compartment 58 holds the planner 12 and may also hold extra supplies such as folders containing blank paper or notebooks. The last compartment 59 holds the folders, in class order, that the student attends following lunch.

The organizer system 10 is customized for an individual student's schedule and/or learning needs. The organizer system 10 could also be customized at different levels, such as for a particular school, a particular grade level, or a particular class. For example, the system could be customized in bulk for the particular school-year calendar and subject offerings of that particular school. Or, the system could further be customized for an individual student.

As shown in FIG. 7, this customization may he done in several ways. For example, the color-coded planner sheets 14 that correspond to the individual's schedule can he customized using software and then printed 300. in another embodiment 302, the individual's schedule can be conveyed to a printing facility via the Internet, telephone, or in writing and then the printing facility uses software to customize the planner sheets 14. The folders 16 are also labeled according to the subject matter that has been assigned to that color.

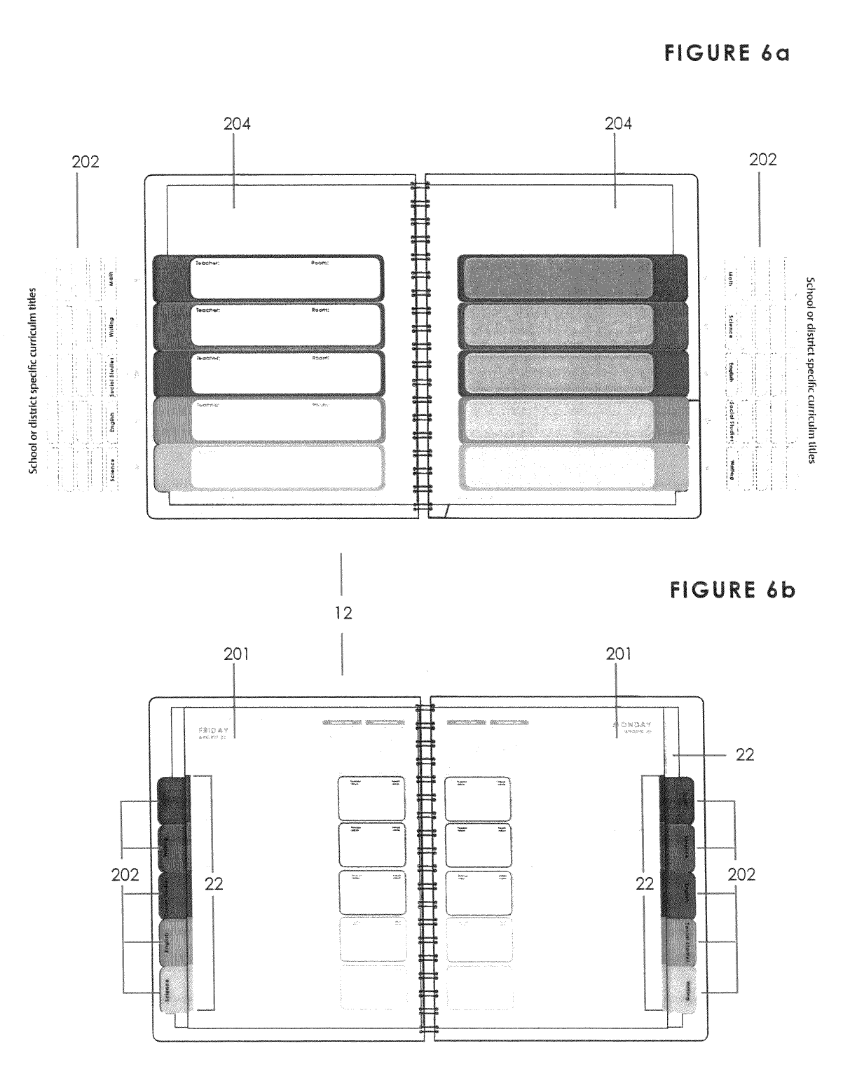

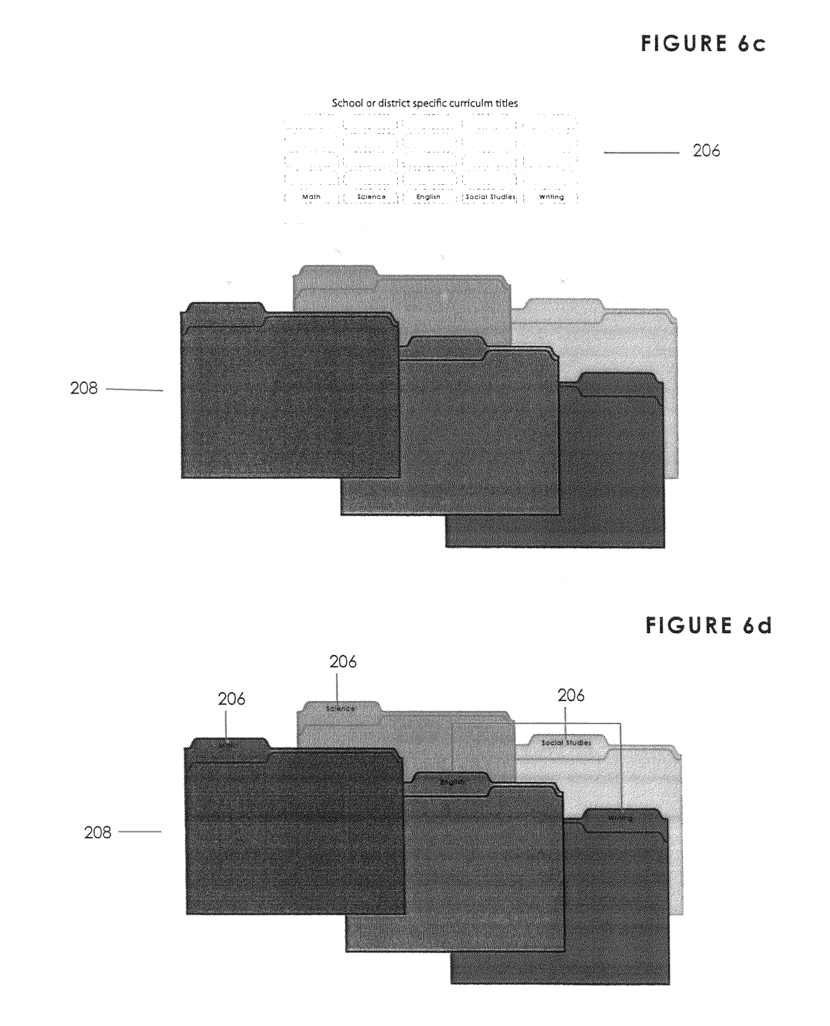

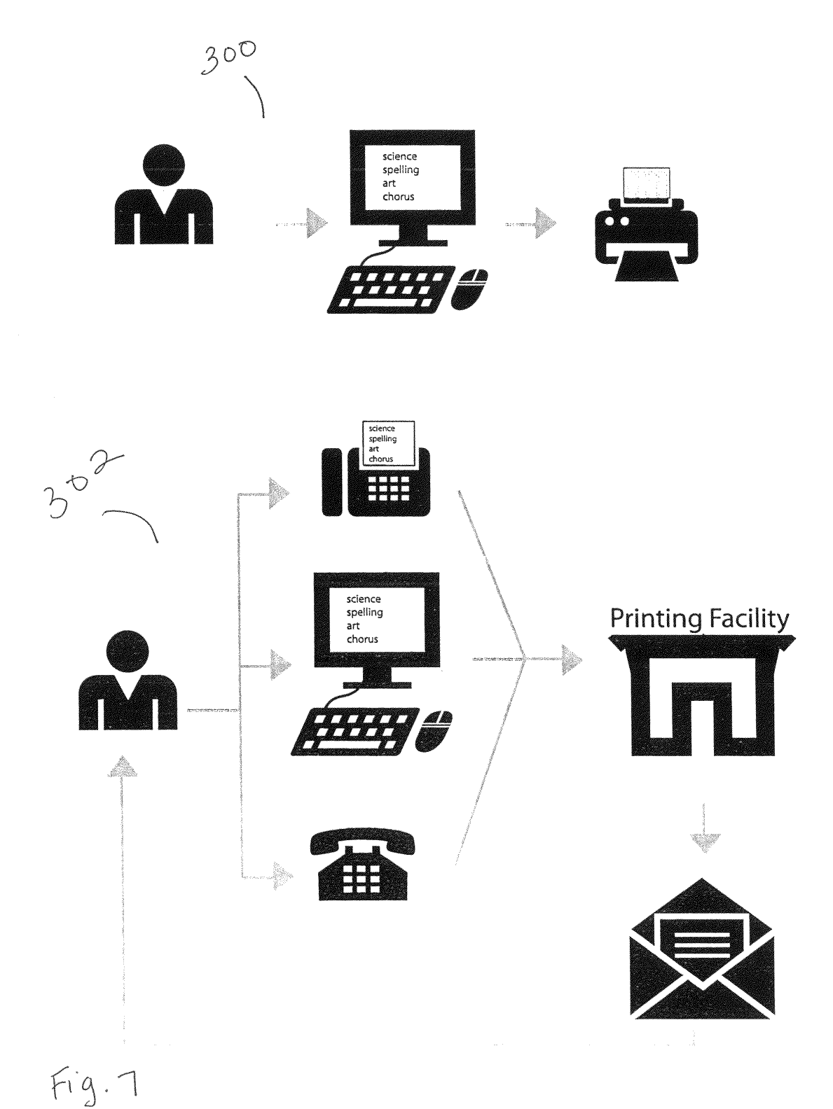

In a manually customized embodiment 200, the organization system is customized by hand, using stickers. This embodiment is shown in FIGS. 6a-6d. Customized, color-coded tabs make a base sheet 204. The base sheet 204 is divided into color-coded sections representing individual subjects. Preprinted stickers or tabs (or stickers/tabs printed by the student or parent) 202 with standard class names are provided in various colors to coordinate with varying schedules. Additional blank stickers may be provided to be printed or written on to customize the base beyond standard class names. Assembling planner pages 201 with tab page base 204 and stickers 202 creates a color-coded, labeled, custom planner for individual students, as seen in FIG. 6b. Additional stickers 206 with standard class names in various colors are provided to attach to the corresponding color-coded folders 208, as seen in FIGS. 6c-6d.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention. For example, the color-coding aspect is just one way of distinguishing and organizing subjects. It is contemplated that other ways to differentiate between subjects are within the scope of the invention. For instance, different patterns or symbols may be used to represent math, English, etc.

1. An organizational system comprising a planner customized for a particular group, wherein said planner further comprises at least schedule sheet representing at least one calendar day having a plurality of sections, wherein a first section comprises a plurality of subsections for recording assignments, each subsection representing a different academic subject.

2. The organizational system of claim 1, wherein the planner is customized for a school district's schedule.

3. The organizational system of claim 1, wherein the planner is customized for a school's schedule.

4. The organizational system of claim 1, wherein the planner is customized for a classroom's schedule.

5. The organizational system of claim 1, wherein the planner is customized for an individual's schedule.

6. The organizational system of claim 1, wherein the planner is customized by relating a different identifying color to each academic subject.

7. The organizational system of claim 6, wherein the academic subject subsections are ordered according to each day's schedule with the first subject of the day appearing at the top of the each day section of the schedule sheet and the last subject of the day appearing at the bottom of the each day section of the schedule sheet.

8. The organizational system of claim 7, wherein a second section comprises color-coded communication boxes, wherein the communication boxes are color-coded by academic subject.

9. The organizational system of claim 7, wherein the day sheet further comprises a month view calendar.

10. The organizational system of claim 1, wherein the planner further comprises at least one pocket.

11. The organizational system of claim 1, further comprising a plurality of folders customized for a particular group.

12. The organizational system of claim 11, wherein the folders are color-coded based on academic subject.

13. The organizational system of claim 1, further comprising a carrying device.

14. The organizational system of claim 12, further comprising a carrying device.

15. The organizational system of claim 14, wherein the carrying device further comprises a plurality of compartments.

16. A method of implementing an organizational system, comprising the steps of customizing a planner for a particular group, wherein said planner further comprises at least one schedule sheet representing at least one calendar day having a plurality of sections, wherein a first section comprises a plurality of subsections for recording assignments, each subsection representing a different academic subject.

17. The method of claim 16, wherein the planner is customized by color-coding each academic subject and ordering each academic subject in the schedule sheet in order of the daily academic subject schedule.

18. The method of claim 17, wherein the customization is completed manually.

19. The method of claim 17, wherein the customization is completed at a remote location.
